(19) United States
(12) Patent Application Publication
(10) Pub. No.: US 2010/0093358 A1
(43) Pub. Date: Apr. 15, 2010

(54) WIRELESS COMMUNICATION SYSTEM AND HANDOVER METHOD THEREIN

(75) Inventors: Dong Jo CHEONG, Yongin-si (KR); Jong Hyune KIM, Seoul (KR); Lifeng, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/578,305

(22) Filed: Oct. 13, 2009

(30) Foreign Application Priority Data
Oct. 13, 2008 (KR) 10-2008-0100313

(51) Int. Cl. H04W 36/00

(52) U.S. Cl. 455/444

(57) ABSTRACT

A wireless communication system and handover method for the wireless communication system are provided. A handover method for a wireless communication system including a plurality of femto cells and at least one macro cell within which the femto cells are disposed includes determining, at a Radio Network Controller (RNC), a handover of a terminal to a femto base station based on a measurement report of the terminal and preset handover parameters, sending a radio link setup request message to a femto base station gateway, the radio link setup request message including a uplink scrambling code and an International Mobile Subscriber Identity (IMSI) of the terminal and a Logical Cell Identifier (LCID) of femto base stations reusing frequency of a macro base station, searching, at the femto base station gateway, for femto base stations of which LCIDs match the LCID contained in the radio link setup request message, and performing, when only one LCID-matched femto base station is discovered, the handover of the terminal to the LCID-matched femto base station.

### PRIORITY

This application claims the benefit under 35 U.S.C. §119(a) of a Korean patent application filed in the Korean Intellectual Property Office on Oct. 13, 2008 and assigned Serial No. 10-2008-0100313, the entire disclosure of which is hereby incorporated by reference.

### BACKGROUND OF THE INVENTION

1. Field of the Invention

The present invention relates to wireless communications. More particularly, the present invention relates to a wireless communication system and a femto base station-friendly handover method therein.

2. Description of the Related Art

Femto cells are a low cost means of providing ubiquitous connectivity in broadband wireless communication networks. The term “femto” is a prefix denoting a factor of 10⁻¹⁵ in the International System of Units. In the context of telecommunications, the term “femto cell” refers to a tiny cellular base station for use in home or small business. Sometimes, the term “femto cell” is used interchangeably with the term “pico cell.” However, a pico cell is different than a femto cell in terms of functionality. A femto cell is connected to a broadband network router via a wired link and is responsible for delivering the 2^{nd} Generation (2° G.) and 3^{rd} Generation (3° G.) voice and data traffic to a backbone network of a mobile operator.

The femto cell is designed to allow service providers to extend service coverage indoors, especially where access would otherwise be limited or unavailable, by connecting to a commercial broadband line or cable modem installed in a home.

The femto cell improves both the coverage and capacity of the wireless communication system. Since the indoor femto base station allows a small number of mobile terminals to use dedicated air resources in its reduced size coverage area, unlike the macro cell in which bandwidth is shared by a large number of users, it is possible to provide high speed and broadband services. The advantages of deployment of the femto cell is expected to be leveraged with future broadband networks.

In the meantime, handover between the femto cell and the macro cell is a key function in securing service continuity while the user is roaming.

Since a large number of femto cells can be deployed within a macro cell, there are many problems to be addressed to allow a conventional mobile terminal to perform handover between the femto and macro cells, especially handover from the macro cell to a femto cell.

In a case where a plurality of femto cells are located within a macro cell, the mobile terminal should know the Primary Scrambling Codes (PSCs) of all the femto cells to determine to which femto cell to handover. Accordingly, when a number of femto cells increases in the entire system, a PSC shortage is likely to occur, resulting in degradation of the system throughput and handover failure.

### SUMMARY OF THE INVENTION

An aspect of the present invention is to address at least the above-mentioned problems and/or disadvantages and to provide at least the advantages described below. Accordingly, an aspect of the present invention is to provide a wireless communication system and handover method therein that is capable of avoiding a shortage of Primary Scrambling Codes (PCSs), when a number of femto cells in the system is increased, by allocating a reusable logical identifier to the femto cells.

In addition, the present invention provides a wireless communication system and handover method therein that is capable of improving a probability of handover to a femto cell in a communication environment where macro cells overlay a plurality femto cells.

In accordance with an aspect of the present invention, a handover method for a wireless communication system including a plurality of femto cells and at least one macro cell within which the femto cells are disposed is provided. The method includes a plurality of femto cells and at least one macro cell overlaying the femto cells includes determining, at a Radio Network Controller (RNC), a handover of a terminal to a femto base station based on a measurement report of the terminal and preset handover parameters, sending a radio link setup request message to a femto base station gateway, the radio link setup request message including an uplink scrambling code and an International Mobile Subscriber Identity (IMSI) of the terminal and a Logical Cell Identifier (LCID) of femto base stations reusing a frequency used by a macro base station, searching, at the femto base station gateway, for femto base stations having LCIDs that match the LCID contained in the radio link setup request message, and performing, when only one LCID-matched femto base station is discovered, the handover of the terminal to the LCID-matched femto base station.

In accordance with another aspect of the present invention, a wireless communication system is provided. The system includes a plurality of femto cells and at least one macro cell overlaying the femto cells includes an RNC for determining a handover of a terminal to a femto base station based on a measurement report of the terminal and preset handover parameters and for sending a radio link setup request message including an uplink scrambling code and an IMSI of the terminal and a LCID of femto base stations reusing a frequency used by a macro base station, and a femto base station gateway for searching for femto base stations having LCIDs that match the LCID contained in the radio link setup request message transmitted by the RNC and for performing, when only one LCID-matched femto base station is discovered, the handover of the terminal to the LCID-matched femto base station.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic diagram illustrating a wireless communication system according to an exemplary embodiment of the present invention;

FIG. 2 is a conceptual diagram illustrating a Hierarchical Cell Structure (HCS) system architecture according to an exemplary embodiment of the present invention;

FIG. 3 is flowchart illustrating a femto cell parameter configuration procedure of a handover method according to an exemplary embodiment of the present invention;

FIG. 4 is a sequence diagram illustrating operations of network elements for configuring handover parameters in a handover method according to an exemplary embodiment of the present invention;

FIG. 5 is a diagram illustrating a Logical Cell Identifier (LCID) configuration for a handover method according to an exemplary embodiment of the present invention;

FIG. 6 is a sequence diagram illustrating operations of network elements in a femto cell-friendly handover method according to an exemplary embodiment of the present invention; and

FIG. 7 is a flowchart illustrating a femto cell-friendly handover according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and construction are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

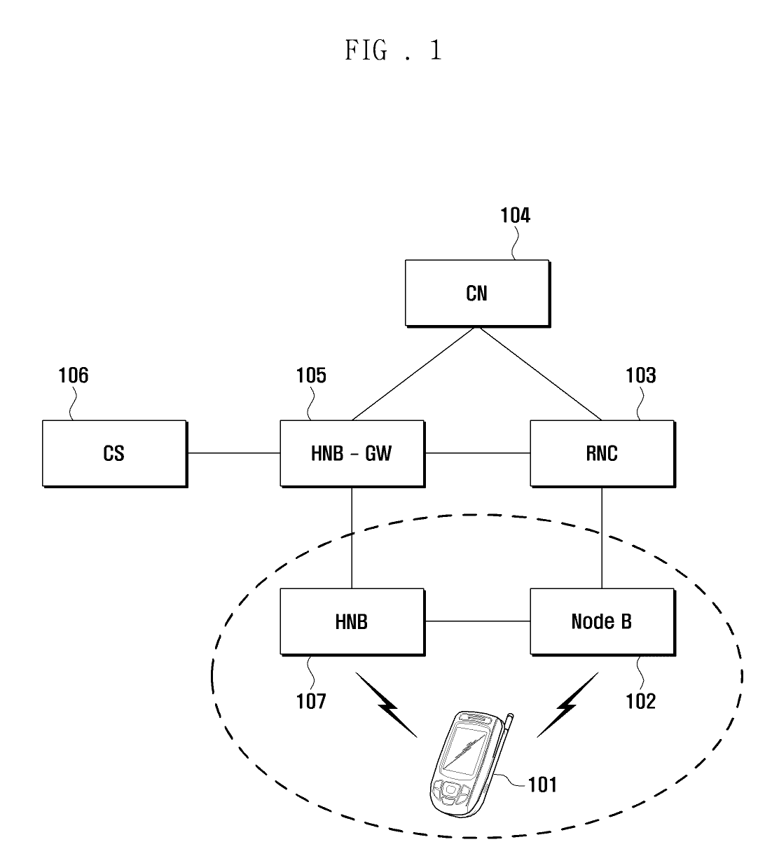

A wireless communication system architecture according to an exemplary embodiment of present invention is described with reference to FIG. 1. FIG. 1 is a schematic diagram illustrating a wireless communication system according to an exemplary embodiment of the present invention.

Referring to FIG. 1, the wireless communication system according to an exemplary embodiment of the present invention includes a Node B 102, a Radio Network Controller (RNC) 103, a Home Node B (HNB) 107, an HNB Gateway (HNB-GW) 105, a Configuration Server (CS) 106, and a Core Network (CN) 104. In the following description, the term “Node B” is used interchangeably with the terms “macro Node B”, “macro base station”, and “macro cell”; and the term “HNB” is used interchangeably with the terms “Home Node B”, “femto Node B”, and “femto cell.”

The wireless communication system further includes at least one User Equipment (UE) 101. In the following description, the term “UE” is used interchangeably with the term “User Equipment” and “mobile terminal”. In FIG. 1, it is assumed that the UE 101 connected to the macro base station 102 moves into the femto cell of the femto base station 107.

The macro base station is a base station managing a macro cell and macro cell denotes a radio cell of a conventional cellular communication system. The femto base station is a base station managing a cell smaller than the macro cell in size. Typically, the femto base station is installed indoors to cover a small space such as a home or a room, and multiple femto base stations may be installed within a macro cell.

In FIG. 1, the femto base station 107 is installed in the coverage area of the macro cell 102. The femto base station can be installed to extend the service coverage area to indoor or outdoor shadow areas or improve the capacity of the wireless communication system for high quality data service in a specific area.

The macro base station 102, the RNC 103, and the CN 104 are the network elements for a macro system.

The femto base station 107, the HNB-GW 105, and the CS 106 are network elements for a femto system. The femto base station 107 and the HNB-GW 105 are connected through an Iu-h interface, and the HNB-GW 105 and the CN 104 are connected through an Iu interface, which is also interfacing the RNC 103 and the CN 104.

Handover of the mobile UE 101 from the macro base station 102 to the femto base station 10 is described hereinafter in the context of the structure of the wireless communication system described above.

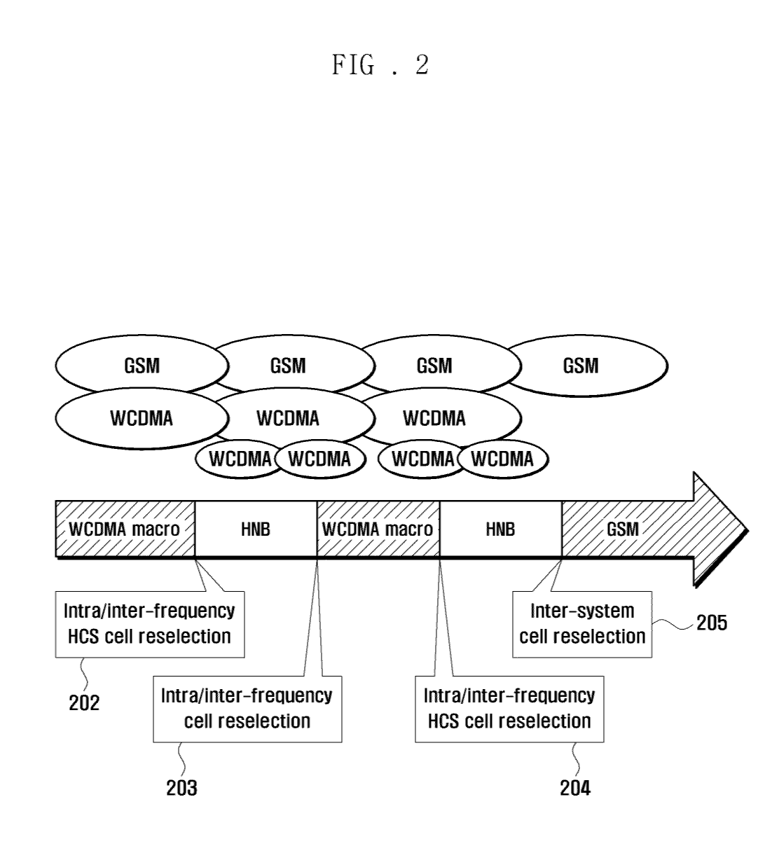

The conditions for determining a handover in a Hierarchical Cell Structure (HCS) according to an exemplary embodiment of the present invention are described with reference to FIG. 2. FIG. 2 is a conceptual diagram illustrating an HCS system architecture according to an exemplary embodiment of the present invention.

Referring to FIG. 2, the HCS system includes a plurality of Wideband Code Division Multiple Access (WCDMA) macro cells and Global Systems for Mobile communication (GSM) macro cells. More particularly, WCDMA femto cells are deployed so as to overlap with the WCDMA macro cells.

In an exemplary embodiment of the present invention, the cells are deployed in an overlapping topology. In a case where the UE 101 moves into an overlapping area between a WCDMA macro cell and a WCDMA femto cell, an intra/inter-frequency HCS cell reselection procedure is initiated as denoted by reference numeral 202. In a case where the UE 101 moves out of the coverage area of the WCDMA femto cell and into the coverage area of another WCDMA macro cell, an intra/inter-frequency cell reselection procedure is initiated as denoted by reference numeral 203. In a case where the UE 101 moves into an overlapping area between the other WCDMA macro cell and a WCDMA femto cell, an intra/inter-frequency HCS cell reselection procedure is initiated as denoted by reference numeral 204. In a case where the UE 101 moves out of the coverage area of both the other WCDMA macro and the WCDMA femto cell, an inter-system cell reselection procedure is initiated as denoted by reference numeral 205.

The handover from the macro base station 102 to the femto base station 107 can be accomplished with a Radio Network Subsystem Application Part (RNSAP) protocol on the Iur interface or a Radio Access Network Application Part (RANAP) protocol on the Iu interface through a CN-involved Serving Radio Network Subsystem (SRNS) Relocation method. In an exemplary embodiment of the present invention, the handover from the macro base station 102 to the femto base station 107 using the RNSAP protocol is described as an example.

The femto base station 107 is installed within the coverage area of the macro base station 102, and the received signal strength of the macro base station 102 is very strong as compared to that of the femto base station 107.

Accordingly, in the area where the received signal strength of the macro base station 102 is greater than a handover threshold value of the femto base station 107, there is little possibility for the UE 101 to camp on the femto base station 107.

In an exemplary embodiment of the present invention, a femto cell parameter is set to facilitate handover to the femto base station 107.

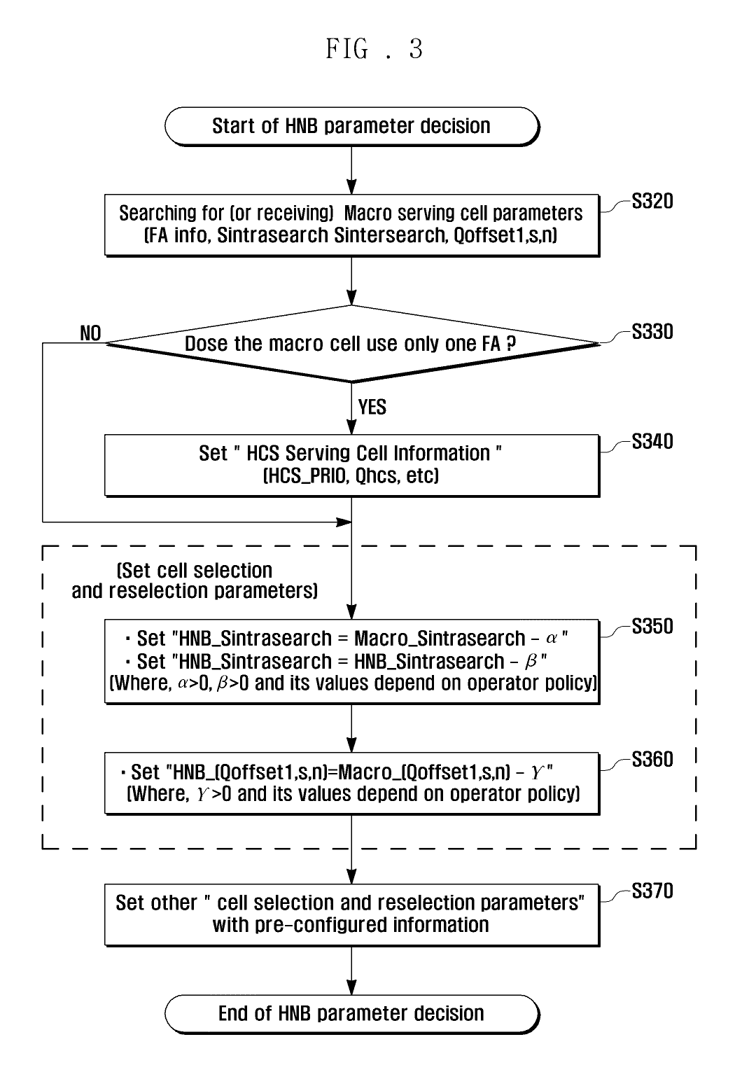

FIG. 3 is flowchart illustrating a femto cell parameter configuration procedure of a handover method according to an exemplary embodiment of the present invention.

Referring to FIG. 3, the HNB-GW 105 searches for or receives macro serving cell parameters of the macro base station 102 (i.e. the serving cell) in step S320. The macro serving cell parameters may include Frequency Allocation (FA) information, Sintrasearch, Sintersearch, Qoffset1, s, and n.

After acquiring the macro serving cell parameters, the HNB-GW 105 determines whether the macro base station 102 uses only one FA channel based on a result of the search in step S330. If it is determined that the macro base station 102 uses only one FA channel, the HNB-GW 105 sets parameters related to the priority of “HCS Serving Cell Information” in step S340. The priority-related parameters may include an HCS priority (HCS_PRIO), a Qhcs, etc.

At this time, the HNB-GW 105 sets the handover priority of the femto base station 107 to be higher than that of the macro base station 102 such that the handover to the femto base station 107 occurs based on the handover priority regardless of the received signal strength of the macro base station 102.

If it is determined that the macro base station 102 uses more than one FA channel, the HNB-GW 105 skips step 340 and sets cell selection and reselection parameters based on equations (1) to (3) in steps S350 and S360. At this time, the values of Sintrasearch, Sintersearch, and Qoffset are determined. In the equations 1 to 3, α, β, and γ can be set to values greater than zero according to the mobile operator's management policy.

HNB_Sintrasearch=Macro_Sintrasearch−α (1)

HNB_Sintersearch=HNB_Sintrasearch−β (2)

HNB_(Qoffset1,s,n)=Macro_(Qoffset1,s,n)−γ (3)

As shown in equations (1) and (2), the threshold value of the received signal strength for the femto base station 107 that triggers the intra-frequency and inter-frequency handovers is set to be lower than that for the macro base station 102 in consideration that the signal strength of the macro base station 102 is stronger than that of the femto base station 107. That is, since the signal strength of the femto base station 102 is weaker than that of the macro base station 107 even when the UE 101 enters the coverage area of the femto base station 102, it is required to adjust the threshold value of the femto cell's signal strength for triggering handover.

By setting the intra-frequency handover trigger threshold value “Sintrasearch” and the inter-frequency handover trigger threshold value “Sintersearch” of the femto base station 107 to lower than those of the macro base station 102, the HNB-GW 105 can determine the handover to the femto base station 107 even when the received signal strength of the femto cell is not strong enough for normal handover.

From equation (3), it is shown that the handover parameter of the femto base station 107 is also set to a value less than that of the macro base station 102 in consideration that the femto base station is placed within the coverage area of the macro base station 102.

The offset between the received signal strengths of the current service cell and the femto cell 107 for cell selection, i.e. Qoffset, is set to a value less than a value between the received signal strengths of the serving cell and the macro base station 102. In this way, the UE 101 can perform the handover to the femto base station 107 even when the signal strength of the femto base station 107 is not strong enough, as compared to that of the service cell.

After completing the parameter settings at steps S350 and S360, the HNB-GW 105 sets other parameters related to the cell selection and reselection in step S370 and finishes the femto base station parameter configuration procedure.

By setting the parameters related to the handover in a femto cell-first manner, the UE 101 attempts to camp on the femto base station 107 first even though the macro base station 102 is superior to the femto base station 107 in received signal strength. At this time, a hysteresis is implemented to avoid the ping-pong effect. In a case where the UE 101 served by the femto base station 107 performs the cell reselection process, it is preferred that the UE 101 select the femto base station 107 rather than the macro base station 102 despite the fact that received signal strength from the macro base station 102 is usually superior than that from the femto base station 102.

In the conventional system, when the femto cell and the macro cell use different frequencies, the threshold value for inter-FA reselection is relatively low. Accordingly, the likelihood of camping on the femto base station 107 is very low in an area where the signal strength of the macro base station 102 is stronger than the handover trigger threshold value of the femto base station 107. In an exemplary embodiment of the present invention, the cell selection procedure is designed such that the UE 101 first selects a cell based on a preference priority. Even in a case where the macro base station uses multiple frequency channels, the handover method according to an exemplary embodiment of the present invention facilitates camping on the femto base station in an Inter-FA handover situation.

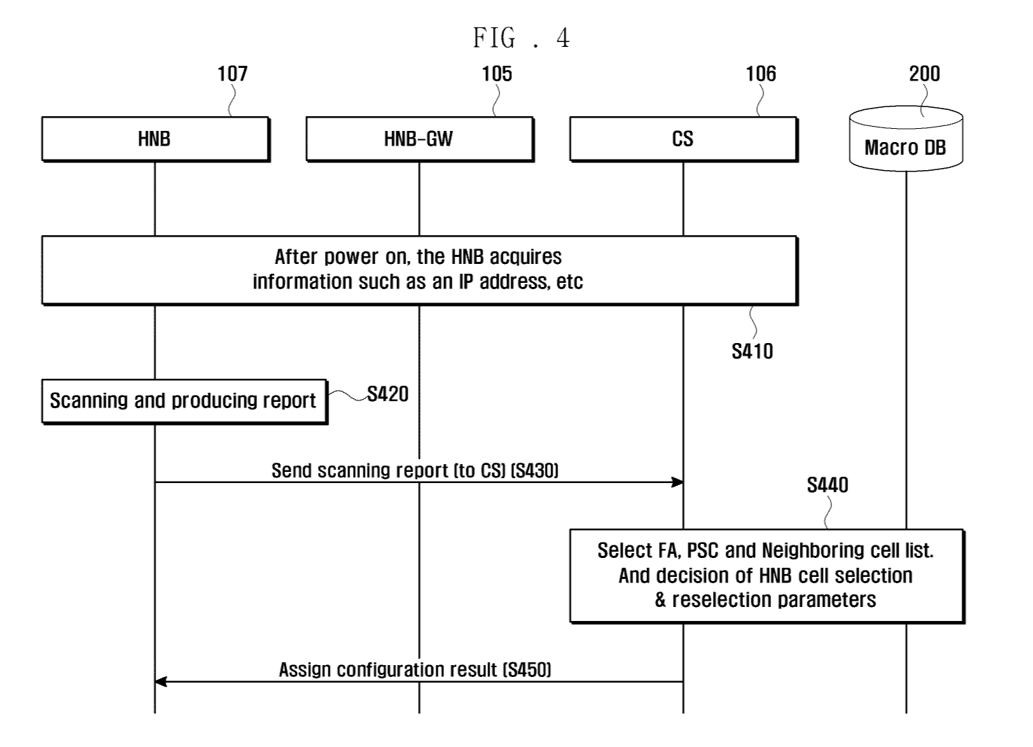

A macro cell parameter configuration procedure according to an exemplary embodiment of the present invention is described hereinafter with reference to FIG. 4. FIG. 4 is a sequence diagram illustrating operations of network elements for configuring handover parameters in a handover method according to an exemplary embodiment of the present invention.

Referring to FIG. 4, when the femto base station 107 powers on, the femto base station 107 accesses the CS 106 via the HNB-GW 105 and acquires information such as an IP address, etc. in step S410.

Next, the femto base station 107 scans for base stations and produces a scanning report in step S420. Next, the femto base station 107 sends the scanning report to the CS 106 in step S430.

Upon receipt of the scanning report, the CS 106 establishes a connection to a macro DB 200, acquires the information on the macro base station 102 to which the femto base station 107 belongs, and sets parameters of the femto base station 107 as described with reference to FIG. 3 in step S440. That is, the Sintrasearch, Sintersearch, and Qoffset of the femto base station 107 are calculated by equations (1) to (3) based on the corresponding parameters of the macro base station 102, and a preference priority is determined. In equations (1) to (3), the parameters α, β, and γ are set to values greater than zero according to the mobile operator's management policy.

Next, the CS 106 sends the configuration result containing the parameter values set at step 440 to the femto base station 107 in step S450.

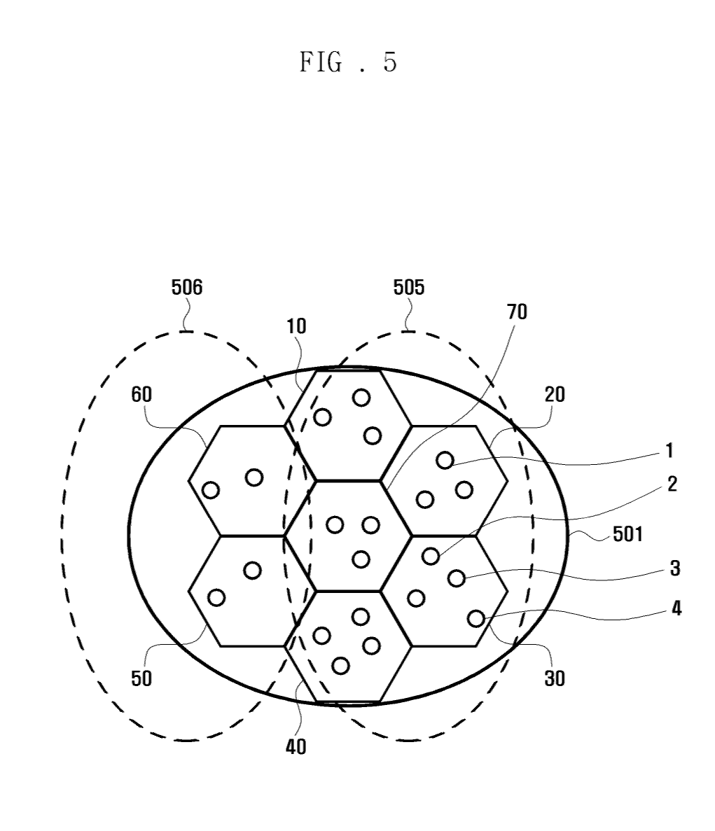

The configuration of a Logical Cell ID (LCID) for the femto cell 107 is described hereinafter with reference to FIG. 5. FIG. 5 is a diagram illustrating an LCID configuration for a handover method according to an exemplary embodiment of the present invention.

Referring to FIG. 5, the exemplary wireless communication system includes the first to seventh macro cells 10 to 70, and within each macro cell there is disposed a number of femto cells. In FIG. 5, reference numerals 1 to 4 denote first to fourth femto cells (femto base stations).

The macro cells 10 to 70 are under the control of an RNC 501, and the first to fourth femto cells 1 to 4 are connected to the same HNB-GW 505. The femto base station 107 (see FIG. 1) can be connected to more than one HNB-GW under the control of the RNC 501.

Reference numerals 505 and 506 denote HNB-GW regions (for simplicity of explanation, the terms “HNB-GW” and “HNB-GW region” are interchangeably used hereinafter). The RNC region 501 can include one or more HNC-GW regions (for simplicity of explanation, the terms “RNC” and “RNC region” are interchangeably used hereinafter). In the example of FIG. 5, the RNC region 501 includes the two HNB-GW regions 505 and 506.

With this exemplary configuration of the wireless communication system, an LCID allocation method according to an exemplary embodiment of the present invention is described. In accordance with an exemplary embodiment of the present invention, the PSC shortage problem can be addressed by using the PSC of the macro base station for producing LCIDs of the femto base stations.

The PSC can be reused to allocate four types of LCIDs according to the density of the femto base stations per macro cell.

The femto base stations positioned in different macro cells can be allocated different LCIDs. For instance, the first femto cell 1 disposed within the second macro cell 20 and the second femto cell 2 disposed within the third macro cell 30 are allocated different LCIDs. Although two femto cells are located within different macro cells, the same LCID can be allocated to the femto cells. For instance, the first femto cell 1 disposed within the second macro cell 20 and the fourth femto cell 4 disposed within the third macro cell 30 can be allocated the same LCID.

In a case where the frequency resources of the macro base stations are reused, there can be multiple femto base stations allocated the same femto base station identifier according to the increase in the density of the femto base station.

In the above-identified case, the target femto base station can be selected using a neighbor cell list. When the UE 101 requests a handover, the femto base station positioned nearest the serving base station is selected as the target femto base station among the femto base stations allocated the same identifier.

That is, when there are multiple femto base stations allocated the same LCID and the UE 101 requests handover to the cell having the LCID, the femto base station disposed in the macro cell as the serving base station of the UE 101 is selected, among the femto base stations having the same LCID.

As described above, the LCID allocation method is advantageous for managing the neighbor list as in the conventional system without modification of the configuration of RNC 103. In an exemplary embodiment of the present invention, the neighbor list including the macro cells is managed using RNC-ID, CID, and PSC information; and the neighbor list including the femto cells is managed using the HNB-GW corresponding to the RNC-ID and the LCID corresponding to the CID. The RNC 103 and HNB-GW 105 can manage the neighbor list by mapping the RNC-ID or HNB-GW ID, CID or LCID, and PSC information for management of respective macro and femto cells.

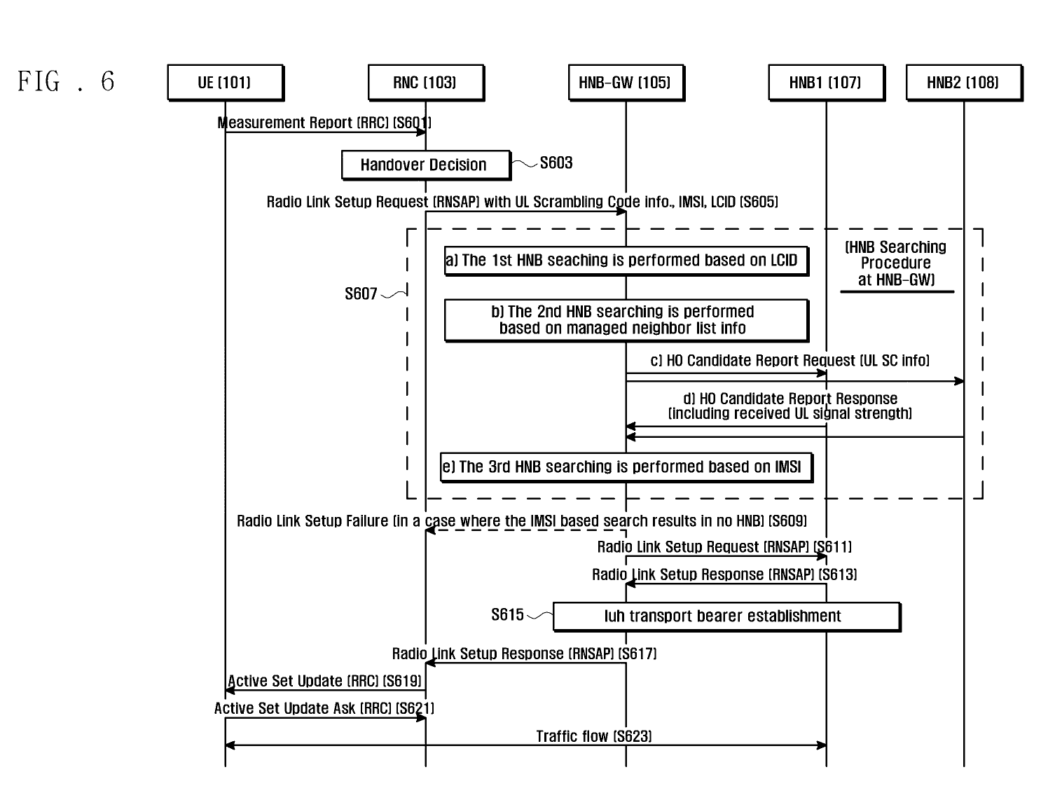

A handover method in a situation after the parameters configuration for the femto base station 107 and the LCID allocation is described herein after with reference to FIG. 6. FIG. 6 is a sequence diagram illustrating operations of network elements in a femto cell-friendly handover method according to an exemplary embodiment of the present invention.

In FIG. 6, the handover procedure is performed on the basis of the Iur handover specified in the 3^{rd} Generation Partnership Project (3GPP) TS25.423 standard, the entire disclosure of which is hereby incorporated by reference, and the HNB-GW 105 is responsible for acquiring and managing neighbor macro cell information with a macro cell sniffer function. FIG. 6 illustrates a handover from the macro base station 102 to the femto base station 107.

Referring to FIG. 6, the UE 101 measures the wireless channels and sends a measurement report to the RNC 103 in step S601.

The measurement report contains the cell identifiers of the neighbor base stations of which received signal strengths are greater than a handover trigger threshold value. In case of a femto base station, the cell identifier can be an LCID.

Upon receipt of the measurement report, the RNC 103 makes a handover decision in step S603. At this time, the RNC 103 makes a handover decision regarding the UE 101 based on the measurement report and preset parameter values. As described with reference to FIGS. 3 and 4, the handover trigger parameter is set to facilitating triggering of the handover to the femto base station 107 even when the received signal strength of the macro base station is strong.

Here, it is assumed that the RNC 103 decides to handover the UE 101 to a femto base station. After making the handover decision, the RNC 103 requests the HNB-GW 105 to set up a radio link in step S605.

The radio link set up request is performed by transmitting a Radio Link Setup Request message to the HNB-GW 105. The Radio Link Setup Request message may include an Uplink (UL) Scrambling Code, an International Mobile Subscriber Identity (IMSI), and an LCID.

Upon receipt of the Radio Link Setup Request message, the HNB-GW 105 performs an HNB searching procedure of step S607. Through the HNB searching procedure, the HNB-GW selects a target femto base station (target HNB) based on the HNB-GW ID, IMSI, and LCID information stored therein and the information about the macro base station 102 to which the femto base station belongs. The macro base station information may be received from the femto base station.

In step a) of the HNB search procedure of step S607, the HNB-GW 105 searches for handover candidate femto base stations. In a case where a single handover candidate femto base station is found, the HNB search procedure proceeds to step e).

More than one handover candidate femto base station using the same LCID may be found at step a). In this case, the HNB-GW 105 narrows down the handover candidate femto base stations using the neighbor list information in step b) of the HNB searching procedure of step S607.

The neighbor list information is acquired as a result of the neighbor base station search for the femto base station 107 as described with reference to FIG. 4, and the HNB-GW 105 searches for the candidate femto base stations using the information carried by the Radio Link Setup Request message. Referring to the example of FIG. 5, the first femto base station 1 and the fourth femto base station 4 have the same LCID, and the HNB-GW 105 searches in the second macro cell 20 or third macro cell 30, in which the UE 101 is disposed when transmitting the measurement report, for the femto base station.

Even in this case, more than one femto base station may be found within a macro cell 102 according to the density of the femto base stations. When only one handover candidate femto base station 107 is found after step b), steps c) and d) of the HNB search procedure of step S607 are skipped and the HNB search procedure proceeds to step e).

In any case, there can be more than two femto base stations, e.g. the third and fourth femto base stations 3 and 4 having the same LCID as in the example of FIG. 5. When multiple handover candidate femto base stations 107 and 108 exist, the HNB-GW 105 sends a Handover (HO) Candidate Report Request message to the corresponding femto base stations 107 and 108 at step c) of the HNB search procedure of step S607.

Upon receipt of the HO Candidate Report Request message, each of the femto base stations 107 and 108 decodes the UL Scrambling Code carried by the HO Candidate Report Request message. The femto base station which has decoded the UL Scrambling Code successfully sends an HO Candidate Report Response message to the HNB-GW 105 at step d) of the HNB search procedure of step S607. The HO Candidate Report Response message contains information on the UL signal strength.

The HO Candidate Report Response message can be transmitted by both the femto base stations 107 and 108. When the HO Candidate Report Response message is received from both the femto base stations 107 and 108, the HNB-GW 105 compares the UL signal strengths of the femto base stations 107 and 108 and selects the femto base station having an UL signal strength that is greater than the other.

Once one of the HO candidate femto base stations is selected, the HNB-GW 105 determines whether the corresponding femto base station permits access of the UE 101 based on the IMSI of the UE 101 at step e) of the HNB search procedure of step S607. The access permission determination can be made by checking whether the IMSI of the UE 101 is included in an Access Control List (ACL) of the HNB-GW 105. This means that each femto base station has an ACL that includes the permitted IMSIs. Accordingly, when the UE 101 attempts to hand over to the femto base station 107, the HO candidate femto base station 107 can accept or deny the access of the UE 101 based on whether the IMSI of the UE 101 exists in its ACL.

In a case where the HO candidate femto base station 107 denies the access of the UE 101, the HNB-GW 105 sends a Radio Link Setup Failure message to the RNC 103 in step S609.

Otherwise, if the HO candidate femto base station 107 accepts the access of the UE 101, the HNB-GW 105 forwards the RNSAP protocol-based Radio Link Setup Request message received from the RNC 103 to the HO candidate femto base station 107 in step S611. Upon receipt of the Radio Link Setup Request message, the HO candidate femto base station 107 sends a Radio Link Setup Response message to the HNB-GW 105 in step S613. As a consequence, an Iuh transport bearer connection is established between the HNB-GW 105 and the femto base station 107 in step S615. Once the Iuh transport bearer connection is established, the HNB-GW 105 sends a Radio Link Setup Response message to the RNC 103 to inform of the establishment of the radio bearer connection to the target base station in step S617.

If the Radio Link Setup Response message is received from the HNB-GW 105, the RNC 103 sends an Active Set Update message to the UE 101 to notify of the radio link update in step S619. Upon receipt of the Active Set Update message, the UE 101 sends an Active Set Update Ask message to the RNC 103 in step S621. As a consequence, the traffic flow is connected to the femto base station 107 and thus the handover to the femto base station 107 is completed in step S623.

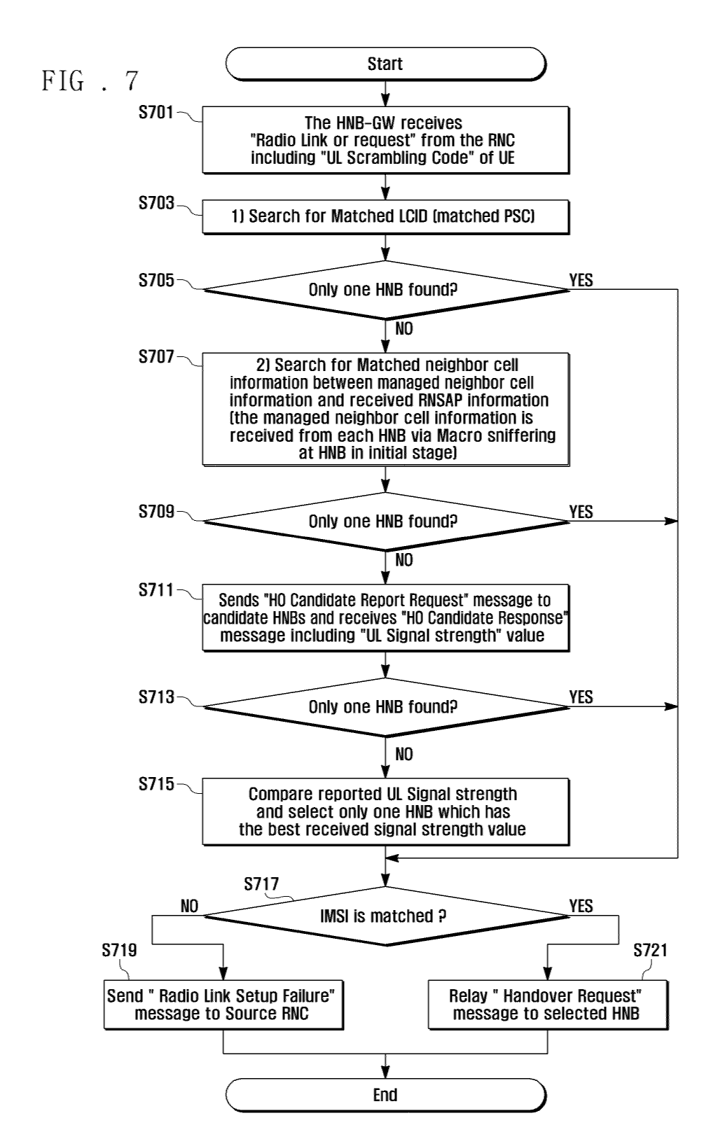

The HNB searching procedure 607 of FIG. 6 is described hereinafter in more detail with reference to FIG. 7. FIG. 7 is a flowchart illustrating a femto cell-friendly handover to according to an exemplary embodiment of the present invention.

Referring to FIG. 7, the HNB-GW 105 receives a Radio Link Setup Request message from the RNC 103 in step S701. The Radio Link Setup Request message may include the UL Scrambling Code and IMSI of the UE 101 and LCID.

Upon receipt of the Radio Link Setup Request message, the HNB-GW 105 searches for the femto base stations having an LCID that matches the LCID carried by the Radio Link Setup Request message in step S703. Next, the HNB-GW 105 determines whether only one LCID-matched femto base station is discovered in step S705. If only one LCID-matched femto base station is discovered, the procedure proceeds to step S717.

If more than one LCID-matched femto base station is discovered, the HNB-GW 105 searches for candidate femto base stations among the LCID-matched femto base station using the neighbor list information in step S707. Next, the HNB-GW 105 determines whether only one candidate femto base station is discovered among the LCID-matched femto base stations in step S709.

If only one candidate femto base station is discovered, the procedure proceeds to step S717. Otherwise, if more than one candidate femto base station is discovered, the HNB-GW 105 transmits the HO Candidate Report Request message to the candidate femto base stations and receives the HO Candidate Report Response messages from the candidate femto base stations in response to the HO Candidate Report Request message in step S711. At this time, each candidate femto base station that received the HO Candidate Report Request message decodes the UL Scrambling Code contained in the HO Candidate Report Request message and the femto base station in which the UL Scrambling Code is decoded successfully transmits the HO Candidate Report Response message to the HNB-GW 105. The HO Candidate Report Response message may include the UL signal strength of the corresponding candidate femto base station. The UL signal strength of the corresponding candidate femto base station may be the UL Pilot strength.

Next, the HNB-GW 105 determines whether the HO Candidate Report Response message is received from only one candidate femto base station in step S713. If the HO candidate Report Response message is received from only one candidate femto base station, the procedure proceeds to step S717.

Otherwise, if the HO candidate Report Response message is received from more than one candidate femto base station, the HNB-GW 105 compares the UL signal strengths carried by the HO Candidate Report Response message transmitted by different candidate femto base stations and selects the candidate femto base station of the best UL signal strength as a target femto base station in step S715.

Once the target femto base station is selected, the HNB-GW 105 determines whether the IMSI of the UE 101 matches one of the IMSIs contained in the ACL in step S717.

If the IMSI of the UE 101 does not match any of the IMSIs of the ACL, the HNB-GW 105 sends a Radio Link Setup Failure message to the RNC 103 in step S719. Otherwise, if the IMSI of the UE 101 matches one of the IMSIs of the ACL, the HNB-GW 105 sends a Handover Request message to the target femto base station in step S721. Here, the Handover Request message can be a Radio Link Setup Request message.

As described above, the wireless communication system and handover method therein according to exemplary embodiments of the present invention allocate reusable logical identifiers to the femto base stations, thereby avoiding PCS shortage due to an increase in a number of femto cells in the system.

In addition, the wireless communication system and handover method therein according to exemplary embodiments of the present invention allow a terminal to perform handover to the femto cell efficiently, in a network environment in which macro cells include a plurality of femto cells, in consideration of the superiority of signal strength of the macro cells to the femto cells.

While the invention has been shown and described with reference to certain exemplary embodiments thereof, it will be understood by those skilled in the art that various changes in form and details may be made therein without departing from the spirit and scope of the invention, as defined in the appended claims and their equivalents.

What is claimed is:

1. A handover method for a wireless communication system including a plurality of femto cells and at least one macro cell within which the femto cells are disposed, the method comprising:
determining, at a Radio Network Controller (RNC), a handover of a terminal to a femto base station based on a measurement report of the terminal and preset handover parameters;
sending a radio link setup request message to a femto base station gateway, the radio link setup request message including an uplink scrambling code and an International Mobile Subscriber Identity (IMSI) of the terminal and a Logical Cell Identifier (LCID) of femto base stations reusing a frequency used by a macro base station;
searching, at the femto base station gateway, for femto base stations having LCIDs that match the LCID contained in the radio link setup request message; and
performing, when only one LCID-matched femto base station is discovered, the handover of the terminal to the LCID-matched femto base station.

2. The method of claim 1, further comprising:
searching, when more than one LCID-matched femto base station is discovered, for candidate femto base stations among the LCID-matched femto base stations using neighbor list information; and
performing, when only one candidate femto base station is discovered, the handover of the terminal to the candidate femto base station.

3. The method of claim 2, further comprising:
sending, when more than one candidate femto base station is discovered, an uplink scrambling code of the terminal to the candidate femto base stations; and
performing, when only one candidate femto base station replies, the handover of the terminal to the candidate femto base station that replied.

4. The method of claim 1, wherein the handover parameters are set for each femto base station to have a higher priority than all macro base stations.

5. The method of claim 1, wherein the handover parameters comprise a handover-triggering signal strength threshold, the handover-triggering signal strength threshold for each femto base station being set to a value less than that for all macro base stations.

6. The method of claim 1, wherein the handover parameters comprise an offset between signal strengths of a serving base station and a handover target base station, the offset for each femto base station being set to a value less than that for all macro base stations.

7. The method of claim 1, wherein the performing, when only one LCID-matched femto base station is discovered, of the handover of the terminal to the LCID-matched femto base station comprises:
determining whether the LCID-matched femto base station permits access of the terminal based on the IMSI of the terminal; and
if it is determined that the LCID-matched femto base station permits access of the terminal, performing the handover of the terminal to the LCID-matched femto base station.

8. The method of claim 7, wherein the determining of whether the LCID-matched femto base station permits access of the terminal based on the IMSI of the terminal comprises:
determining whether the IMSI of the terminal is included in an Access Control List (ACL) of the LCID-matched femto base station at the femto base station gateway.

9. A wireless communication system including a plurality of femto cells and at least one macro cell within which the femto cells are disposed, the system comprising:
a Radio Network Controller (RNC) for determining a handover of a terminal to a femto base station based on a measurement report of the terminal and preset handover parameters and for sending a radio link setup request message including an uplink scrambling code and an International Mobile Subscriber Identity (IMSI) of the terminal and a Logical Cell Identifier (LCID) of femto base stations reusing a frequency used by a macro base station; and
a femto base station gateway for searching for femto base stations having LCIDs that match the LCID contained in the radio link setup request message transmitted by the RNC and for performing, when only one LCID-matched femto base station is discovered, the handover of the terminal to the LCID-matched femto base station.

10. The wireless communication system of claim 9, wherein the femto base station gateway searches, when more than one LCID-matched femto base station is discovered, for candidate femto base stations among the LCID-matched femto base stations using neighbor list information and performs, when only one candidate femto base station is discovered, the handover of the terminal to the candidate femto base station.

11. The system of claim 9, wherein the femto base station gateway sends, when more than one candidate femto base station is discovered, an uplink scrambling code of the terminal to the candidate femto base stations and performs, when only one candidate femto base station replies, the handover of the terminal to the candidate femto base station that replied.

12. The system of claim 9, wherein the handover parameters are set for each femto base station to have a higher priority than all macro base stations.

13. The system of claim 9, wherein the handover parameters comprise a handover-triggering signal strength threshold, the handover-triggering signal strength threshold for each femto base station being set to a value less than that for all macro base stations.

14. The system of claim 9, wherein the handover parameters comprise an offset between signal strengths of a serving base station and a handover target base station, the offset for each femto base station being set to a value less than that for all macro base stations.

15. The system of claim 9, wherein the femto base station gateway, before performing, when only one LCID-matched femto base station is discovered, the handover of the terminal to the LCID-matched femto base station, determines whether the LCID-matched femto base station permits access of the terminal based on the IMSI of the terminal, and if it is determined that the LCID-matched femto base station permits access of the terminal, performs the handover of the terminal to the LCID-matched femto base station.

16. The system of claim 15, wherein the femto base station gateway determines whether the LCID-matched femto base station permits access of the terminal based on the IMSI of the terminal by determining whether the IMSI of the terminal is included in an Access Control List (ACL) of the LCID-matched femto base station.
